(19) United States
(12) Patent Application Publication
(10) Pub. No.: US 2014/0310144 A1
(43) Pub. Date: Oct. 16, 2014

(54) ISSUER TRANSPARENCY TOOL FOR FINANCIAL SERVICES

(71) Applicants: Gregg L. Bienstock, Larchmont, NY (US); Timothy J. Stevens, Stamford, CT (US)

(72) Inventors: Gregg L. Bienstock, Larchmont, NY (US); Timothy J. Stevens, Stamford, CT (US)

(73) Assignee: LUMESIS, INC., Stamford, CT (US)

(21) Appl. No.: 13/861,670

(22) Filed: Apr. 12, 2013

(51) Int. Cl. G06Q 40/04

(52) U.S. Cl. CPC G06Q 40/04
USPC 705/37

(57) ABSTRACT

A computer system and method for providing an issuer submission tool operative to enable issuers of financial instruments and municipal debt a computer platform for delivering information to relevant market spaces. A template is provided for relevant financial and other information to be submitted by issuers of municipal debt. End-users are provided with the financial and other information. Periodic updates of the financial and other information are enabled through a computer facilitated platform.

### CROSS REFERENCE TO RELATED APPLICATIONS

This application claims priority to U.S. Patent Application Ser. No. 61/623,345 filed Apr. 12, 2012 which is incorporated herein by reference in its entirety.

### FIELD OF THE INVENTION

The invention relates to a computer implemented method and data processing system for providing an issuer submission tool. Operative and configured to enable issuers of financial instruments, and particularly municipal debt, an efficient platform to deliver meaningful information to the relevant market space(s).

### BACKGROUND OF THE INVENTION

Currently there are no data repositories and dissemination engines to provide municipal bond market participants financial information in a format other than scanned PDF files, that is updated in a consistent and timely manner and provides Issuers the ability to retrieve comparative data from like municipalities.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a computer implemented method and data processing system for providing an issuer submission tool is described operative and configured to enable issuers of financial instruments, and particularly municipal debt, an efficient platform to deliver meaningful information to the relevant market space(s).

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is a block diagram of a computer system that can be used with certain embodiments of the invention.

### WRITTEN DESCRIPTION OF CERTAIN EMBODIMENTS OF THE INVENTION

The present invention is now described more fully. The invention is not limited in any way to the description described below but is merely an overview description of the invention, which can be embodied in various forms, as appreciated by one skilled in the art. Therefore, it is to be understood that any structural and functional details disclosed herein are not to be interpreted as limiting the invention, but rather are provided as a representative embodiment for teaching one skilled in the art one or more ways to implement the invention. Furthermore, the terms and phrases used herein are not intended to be limiting, but rather are to provide an understandable description of the invention. Additionally like reference numerals are to be understood to refer to like elements.

This application is related to commonly assigned and co-pending U.S. patent application Ser. Nos. 13/046,405, filed Mar. 11, 2011; 61/481,576, filed May 2, 2011; and 61/501,011, filed Jun. 24, 2011, each of which is hereby incorporated by reference in its entirety.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

It is to be appreciated that the embodiments of this invention as discussed below may be incorporated as a software algorithm, program or code residing in firmware and/or on computer useable medium (including software modules and browser plug-ins) having control logic for enabling execution on a computer system having a computer processor. Such a computer system typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

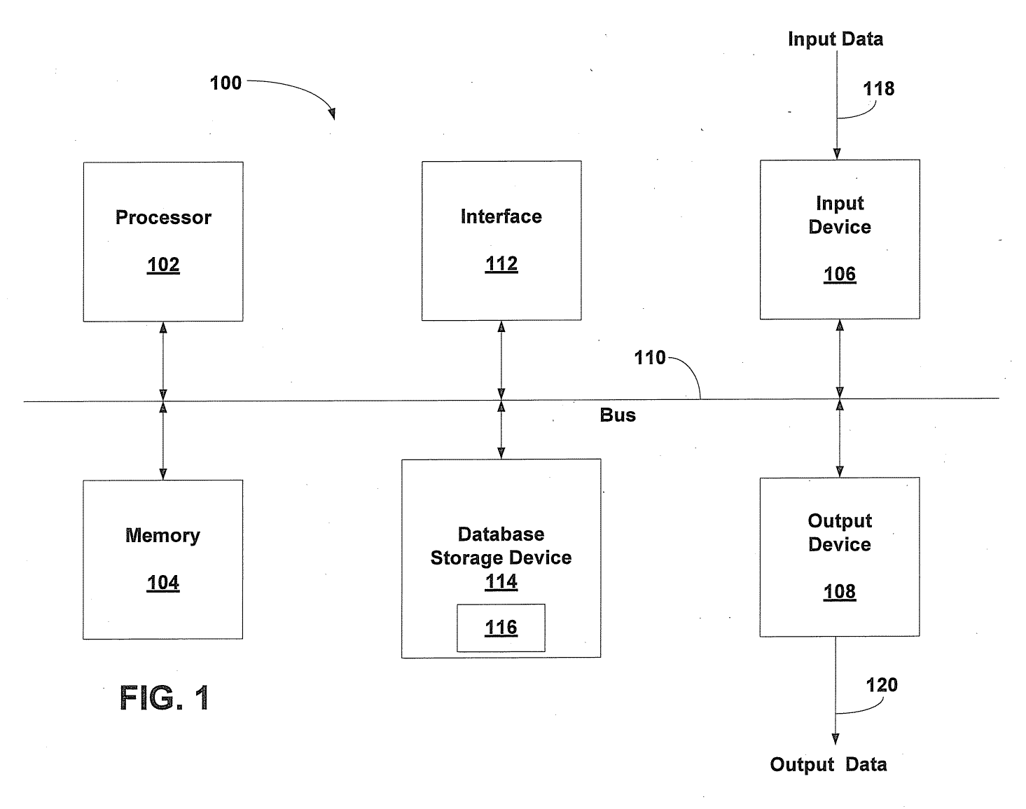

An exemplary computer system is shown as a block diagram in FIG. 1 depicting computer system 100. Although system 100 is represented herein as a standalone system, it is not limited to such, but instead can be coupled to other computer systems via a network (not shown) or encompass other embodiments as mentioned below. System 100 preferably includes a user interface 105, a processor 110 (such as a digital data processor), and a memory 115. Memory 115 is a memory for storing data and instructions suitable for controlling the operation of processor 110.

An implementation of memory 115 can include a random access memory (RAM), a hard drive and a read only memory (ROM), or any of these components. One of the components stored in memory 115 is a program 120. Program 120 includes instructions for controlling processor 110. Program 120 may be implemented as a single module or as a plurality of modules that operate in cooperation with one another. Program 120 is contemplated as representing a software embodiment of the method 200 described herein below.

User interface 105 can include an input device, such as a keyboard, touch screen, tablet, API web services interface or speech recognition subsystem, for enabling a user to communicate information and command selections to processor 110. User interface 105 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 110. In contemplated alternative embodiments of the present invention, the program 120 can execute entirely without user input or other commands based on programmatic or automated access to a data signal flow through other systems that may or may not require a user interface for other reasons.

While program 120 is indicated as already loaded into memory 115, it may be configured on a storage media 125 for subsequent loading into memory 115. Storage media 125 can be any conventional storage media such as a magnetic tape, an optical storage media, a compact disc, a floppy disc, a silicon based memory storage device or the like. Alternatively, storage media 125 can be a random access memory, or other type of electronic storage, located on a remote storage system, such as a server that delivers the program 120 for installation and launch on a user device.

It is to be understood that the invention is not to be limited to such a computer system 100 as depicted in FIG. 1 but rather may be implemented on a general purpose microcomputer incorporating certain components of system 100, such as one of the members of the Sun® Microsystems family of computer systems, one of the members of the IBM® Personal Computer family, one of the members of the Apple® Computer family, or a myriad of other computer processor driven systems, including a: workstations, desktop computers, laptop computers, netbook computers, tablets (e.g., the Apple® IPAD®), a personal digital assistant (PDA), or a smart phone or other like handheld and/or portable devices.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be described in a general context of computer-executable instructions, such as program modules 120, being executed by a computer system 100. Generally, program modules 120 include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules 120 may be located in both local and remote computer storage media including memory storage devices.

With the above exemplary computer system 100 being described above, described below, and in accordance with an illustrated embodiment, a system 200 and method 300 are provided in which municipal bond Issuers are provided with preferably a simple data repository tool to submit timely data and information, preferably in a standard format, and to preferably deliver the same to the MSRB for retail investor access and to institutions and other commercial vendors. It is to be understood and appreciated system 200 and method 300 described herein are to be used in conjunction with above described computer system 100, or components thereof.

It is also to be understood and appreciated an object of the invention is to provide municipal bond issuers an opportunity to enhance transparency and provide the market access to data. Issuers who participate will also have access to information filed by other Issuers providing them a tool for better and more meaningful comparative information. It is to be further understood another embodiment of the invention is for creating a standards based template for CAFR filings.

The present invention system 200 and process 300 is preferably a software and computer driven application executing on a computer 100 enabling a user to enter information on a defined template. This infatuation will include, but not be limited to, financial information, demographic and economic information or other information applicable to the reporting entities status as a State, county, city, town or any other municipal subdivision or entity and also defined by their relevant municipal market defined or self-defined sector. For instance, an embodiment provides sector-based template(s) of key financial measures/metrics that issuers submit on a periodic basis (audited and unaudited); and/or municipal entity-based templates of key financial measures/metrics that issuers submit on a periodic basis (audited or unaudited). It is to be appreciated that in each instance, the measure and metrics may be driven, in part, by GASB's “Preliminary Views of the Governmental Accounting Standards Board on major issues relating to Economic Condition Reporting: Financial Projections” and market/expert feedback.

ITST will be made available to all municipal entities that have or will issue debt and may be available for their use free of charge. Data is preferably uploaded to a database for all Issuers that utilize ITST and the same will be delivered, following submission and necessary aggregation and confirmation, to various third party constituents.

Upon upload to the aforesaid database, the system 200 preferably matches submissions to the corresponding CUSIPs impacted or deemed relevant to the Issuer. The system is further preferably configured and operative to match each Issuer and CUSIP to corresponding geography—State, county, city, school district and the like.

Delivery to third parties preferably includes, on behalf of the Issuer, automated filing with the Municipal Securities Regulatory Board (“MSRB”) as a required or voluntary disclosure and for the MSRB to make such data available on its EMMA platform to the retail market. A subscription data feed may be made available to other third party commercial data providers or institutions.

Issuers that utilize ITST will preferably have access to all information filed by other Issuers and can use ITST to compare their financial and other information, including transparency rating, to like Issuers. Utilizing full database and filtering technology of system 200 enables Issuers to compare prospective and actual primary market yield data against their peers, providing an independent check against price and yield guidance provided by their banker/underwriter.

A further feature of the present invention system 200 and method 300 is the provision of a dynamic user interface configured and operative to accept user data input from a prescribed form preferably made available on the ITST user-interface. As will be appreciated below, the present invention system and process, preferably provides a user configured interface which displays the required form for submission of data and includes relevant space for explanations as required. This data is imported into system 100. Upon initial submission by an Issuer, the ITST preferably checks for completeness and provides indication of missing information to the Issuer prior to final submission. Upon final submission, the Issuer's history of submissions preferably remains available on the Issuer's designated account for necessary updates.

Once the data is verified, all data is preferably tagged with the appropriate CUSIP and Federal Information Processing Standards (FIPS), American National Standards Institute (ANSI) or other geographic identifying code. It is to be appreciated the system of the invention has mapped all CUSIPs to the appropriate FIPS and all issuers to the appropriate State or county. The municipal bonds are assigned to specific political entities such as States, counties, and US territories, protectorates, and subdivisions thereof. Bonds are preferably assigned via a system 200 database created by matching CUSIPs with individual geographical and political entities. This database is preferably periodically updated as additional bonds are issued and as political entities are created or consolidated. Data on new bonds is periodically retrieved (e.g., weekly) via a feed of the CUSIP database and assignment to political entities is done consistent with a set of written procedures aimed at assigning each CUSIP or families of CUSIPs to the political entity most responsible for the repayment of the bond. A user can also preferably override the designated CUSIP mapping for their own use.

It is also to be appreciated the invention is not to be understood to be limited to using FIPS for specifying a geographic area or location, rather the invention may utilize any means for identifying a geographic region, including, but not limited to: American National Standards Institute (ANSI) and InterNational Committee for Information Technology Standards (INCITS) codes. Thus, reference in herein to FIPS shall also mean and encompass any such standard for specifying a geographic area or location.

Once the data is verified, tagged and saved in system 200, the data is formatted for submission to the MSRB and to the Lumesis Database. Once uploaded to system 200, the data is available in the other Lumesis applications, for transmission to the MSRB and to other third party subscribers.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention has been described, it should be understood that various changes, substitutions, and alterations can be made by one of ordinary skill in the art without departing from the scope of the present invention.

What is claimed is:

1. A system comprising:
a memory;
a computer processor disposed in communication with said memory, and configured to issue a plurality of instructions stored in the memory, wherein the instructions issue signals to:
provide an Issuer Transparency Submission Tool (ITST) operative and configured to provide a template for relevant financial and other information to be submitted by issuers of municipal debt and provide end-users with the financial and other information while enabling periodic updates of information through a computer facilitated platform.

2. A computer-implemented method for providing an issuer submission tool operative to enable issuers of financial instruments and municipal debt a computer platform for delivering information to relevant market spaces, said method comprising the steps of:
providing a template for relevant financial and other information to be submitted by issuers of municipal debt;
providing end-users with the financial and other information; and
enabling periodic updates of the financial and other information through a computer facilitated platform.
